(19) United States
(12) Patent Application Publication
(10) Pub. No.: US 2017/0169218 A1
(43) Pub. Date: Jun. 15, 2017

(54) ELECTRONIC DEVICE AND METHOD OF OPERATING THE SAME

(71) Applicant: SAMSUNG ELECTRONICS CO., LTD., Suwon-si (KR)

(72) Inventors: Hyun-cheol PARK, Yongin-si, Gyeonggi-do (KR); Nandi Dharma Kishore H.N., Suwon-si, Gyeonggi-do (KR)

(21) Appl. No.: 15/352,818

(22) Filed: Nov. 16, 2016

(30) Foreign Application Priority Data
Dec. 14, 2015 (KR) 10-2015-0178525

(51) Int. Cl. G06F 21/55; G06F 9/44; G06F 21/56

(52) U.S. Cl. CPC G06F 21/554; G06F 21/566; G06F 9/442; G06F 21/558

(57) ABSTRACT

Provided is an electronic device including a sensor configured to detect a power-off input regarding the electronic device; a processor; a memory for storing one or more programs and the processor being configured to execute the one or more programs, wherein the one or more programs include instructions for, when the power-off input is detected, monitoring opening of resources included in the electronic device by at least one process and, if a resource to be used by the at least one process is an important resource, preventing the resource from being opened.

### CROSS-REFERENCE TO RELATED APPLICATION

This application is based on and claims priority under 35 U.S.C. §119 to Korean Patent Application No. 10-2015-0178525, filed on Dec. 14, 2015, in the Korean Intellectual Property Office, the disclosure of which is incorporated by reference herein in its entirety.

### BACKGROUND

1. Field

The present disclosure relates generally to an electronic device and a method of operating the same, and for example, to an electronic device for detecting malwares and a method of operating the same.

2. Description of Related Art

As electronic devices, such as smart TVs, smart phones, and tablet PCs, are being popularized lately, hardware and software of electronic devices are dramatically developed, and thus operation environments of electronic devices are becoming similar to those of PCs. Furthermore, various applications may be downloaded from the internet or app stores to provide convenient functions demanded by users.

However, as various applications are downloaded, malwares including viruses, worms, Trojan horses, and spywares are introduced into electronic devices and cause damages including increased network traffic, system performance degradation, file deletion, and personal information leakage.

Since a smart TV provides standardized interface and platform for applications and may access the internet via a wireless communication, the number of malwares targeting smart TVs are being rapidly increasing, where attacking methods of malwares are also being diversified. Therefore, a method of detecting such malwares is necessary.

### SUMMARY

An electronic device that monitors suspicious activities performed by malicious processes while the electronic device is being turned off, prevents and/or reduces the suspicious activities from being performed, and detects malicious software and a method of operating the electronic device are provided.

Additional aspects will be set forth in part in the description which follows and, in part, will be apparent from the description.

According to an aspect of an example embodiment, an electronic device includes sensing circuitry configured to detect a power-off input regarding the electronic device; a processor; a memory storing one or more programs including instructions to be executed by the processor; the processor being configured to execute the one or more programs to perform operations comprising, when the power-off input is sensed, monitoring use of resources included in the electronic device by at least one process and, if a resource to be opened by the at least one process is an important resource, for preventing the resource from being opened.

The one or more programs may further include instructions for terminating the at least one process if the resource to be opened by the at least one process is an important resource.

The one or more programs may further include instructions for, when the power-off input is sensed, invoking a power-off API, monitoring an activity of the at least one process to open the resource after the power-off API is invoked, and determining whether the resource to be opened is an important resource.

The memory may include a security module that hooks the power-off API and an “open” system call regarding the resource, thereby monitoring use of the resource by the at least one process.

The processor may include a secure environment, and the one or more programs may further include instructions for executing a security module in the secure environment.

The memory may store a first list including at least one binary that does not include a valid digital signature and corresponds to a malicious software, and the one or more programs may further include instructions for detecting a binary corresponding to the at least one process and, if the detected binary is included in the first list, deleting the binary corresponding to the at least one process.

The electronic device may further include a communicator including communication circuitry that receives the first list from an external server.

The electronic device may further including a communicator, wherein the one or more programs may further include instructions for, if the resource is the important resource, generating a report regarding the activity of the at least one process attempted to open the resource and, when the electronic device is rebooted, the communication circuitry of the communicator is configured to transmit the report to an external server.

According to an aspect of another example embodiment, a method of operating an electronic device includes, sensing a power-off input regarding the electronic device; monitoring use of resources included in the electronic device by at least one process; and, if a resource to be opened by the at least one process is an important resource, preventing the resource from being opened.

The method may further include terminating the at least one process if the resource to be opened by the at least one process is an important resource.

The method may further include, when power-off input is sensed, invoking a power-off API, wherein the monitoring of the opening of the resources may include monitoring an activity of the at least one process to open the resource after the power-off API is invoked; and determining whether the resource to be opened is an important resource.

The method may further include hooking the power-off API and an “open” system call regarding the resource.

The method may further include storing a first list including at least one binary that does not include a valid digital signature and corresponds to a malicious software; detecting a binary corresponding to the at least one process; and, if the detected binary is included in the first list, deleting the binary corresponding to the at least one process.

The method may further include receiving the first list from an external server.

The method may further include, if the resource is the important resource, generating a report regarding the activity of the at least one process attempted to open the resource; and, when the electronic device is rebooted, transmitting the report to an external server.

### BRIEF DESCRIPTION OF THE DRAWINGS

These and/or other aspects will become apparent and more readily appreciated from the following detailed description, taken in conjunction with the accompanying drawings, in which like reference numerals refer to like elements, and wherein:

FIG. 1 is a diagram illustrating an example electronic device according to an example embodiment;

FIG. 2 is a block diagram illustrating an example configuration of an electronic device according to an example embodiment;

FIG. 3 is a block diagram illustrating an example configuration of an electronic device according to another example embodiment;

FIG. 4 is a diagram illustrating an example method of operating a security module according to an example embodiment;

FIG. 5 is a flowchart illustrating an example method of operating an electronic device according to an example embodiment;

FIG. 6 is a flowchart illustrating an example method of operating an electronic device according to an example embodiment.

### DETAILED DESCRIPTION

Terminologies used in the description will be briefly described, and then the detailed description of the disclosure will be given.

Although the terms used in the disclosure are selected from generally known and used terms, some of the terms mentioned in the description may have been arbitrarily selected by the applicant, the detailed meanings of which are described in relevant parts of the description herein. Furthermore, the disclosure is understood, not simply by the actual terms used but by the meaning of each term lying within.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification may refer, for example, to units for processing at least one function and operation and can be implemented by hardware components (e.g., including processing circuitry) or software components and combinations thereof.

Reference will now be made in greater detail to example embodiments, examples of which are illustrated in the accompanying drawings, wherein like reference numerals refer to like elements throughout. In this regard, the present example embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

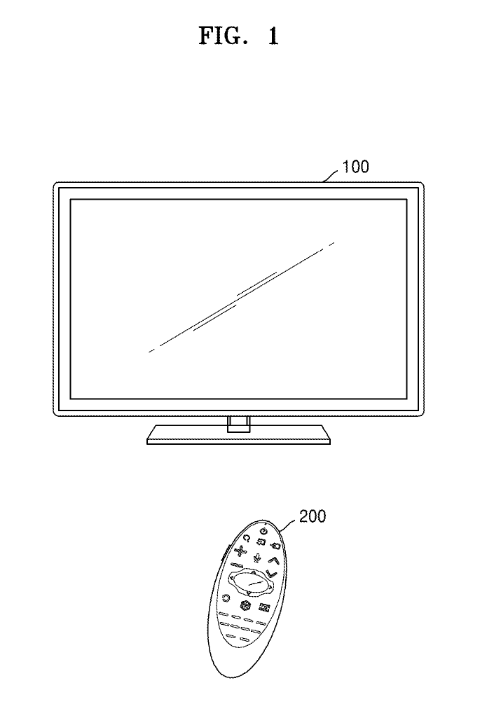

FIG. 1 is a diagram illustrating an example electronic device 100 according to an example embodiment.

As illustrated in FIG. 1, the electronic device 100 may be a TV. However, it is merely an example embodiment, and the electronic device 100 may be implemented as any electronic device including a display. For example, the electronic device 100 may include a mobile phone, a tablet personal computer (PC), a digital camera, a camcorder, a laptop computer, a desktop PC, an e-book port, a digital broadcast port, a personal digital assistant (PDA), a portable multimedia player (PMP), a navigation device, a MP3 player, and a wearable device, or the like. However, the present disclosure is not limited thereto.

The electronic device 100 provides standardized interface and platform for application and may access the internet via a wireless communication. Furthermore, the electronic device 100 may download various applications from the internet or elsewhere.

The electronic device 100 may be controlled by a control device 200. The control device 200 may be implemented as one of various types of devices for controlling the electronic device 100, such as a remote controller or a mobile phone. The control device 200 may include a power on/off button for turning the electronic device 100 on or off. The control device 200 may also change a channel of the electronic device 100, adjust a volume of the electronic device 100, select a ground wave broadcast, a cable broadcast, or a satellite broadcast, or configure a setting.

Furthermore, the control device 200 may control the electronic device 100 by using short-distance communication protocols including an infrared ray communication protocol and Bluetooth protocol. The control device 200 may control functions of the electronic device 100 by using at least one of keys (including buttons), a touch pad, a microphone (not shown) capable of receiving a voice of a user, and a sensor (not shown) capable of recognizing a motion of the control device 200.

In embodiments of the present specification, the term “user” refers to a person who controls functions or operations of the electronic device 100 by using the control device 200 and may include a viewer, an administrator, or an installation technician.

When a power-off input regarding the electronic device 100 is input, the electronic device 100 may perform a power-off operation. For example, if an input that presses the power-off button of the control device 200 is sensed, the electronic device 100 may sense the input as a power-off command. However, the present disclosure is not limited thereto.

When a power-off operation is initiated, the electronic device 100 closes resources included in the electronic device 100 before the electronic device 100 is turned off. For example, the electronic device 100 may control processes being executed on the electronic device 100 to close resources.

The electronic device 100 may monitor whether at least one process exhibits a suspicious activity while the power-off operation is being performed. Suspicious activities may include an activity for using an important resource included in the electronic device 100, an activity for accessing or modifying secure data, a secure process, privacy data, a privacy process, confidential data, or a confidential process, an activity for transmitting data to an external device, and an activity for downloading data (e.g., a malicious payload) from an external device. However, the present disclosure is not limited thereto.

When a suspicious activity is detected, the electronic device 100 may terminate the suspicious activity and delete a malicious process. Furthermore, the electronic device 100 may generate a report regarding the suspicious activity and the malicious process and transmit the report to an external server.

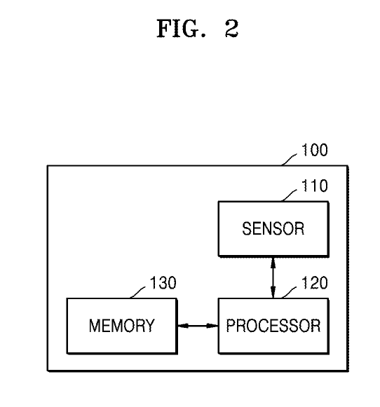

FIG. 2 is a block diagram illustrating an example configuration of an electronic device according to an example embodiment. The electronic device of FIG. 2 may be an example embodiment of the electronic device of FIG. 1.

Referring to FIG. 2, an electronic device 100 according to an example embodiment may include a sensor (e.g., including sensing circuitry) 110, a processor 120, and a memory 130.

The sensor 110 may include various circuitry configured to sense a voice of a user, an image of the user, or an interaction of the user.

The sensing circuitry of the sensor 110 may sense a power-off input regarding the electronic device 100. For example, sensing a power-off input regarding the electronic device 100 may include sensing input of a power-off button included in the electronic device 100, sensing input of a power-off button included in the control device 200, a power-off of the electronic device 100 based on a time setting, and sensing a voice or a gesture of a user corresponding to a power-off command. However, the present disclosure is not limited thereto.

The processor 120 may execute one or more programs stored in the memory 130.

The processor 120 may include a single core, dual cores, triple cores, quad cores, and cores in multiples of 4. Furthermore, the processor 120 may include a plurality of processors. For example, the processor 120 may include a main processor (not shown) and a sub processor (not shown) that operates in a sleep mode.

The memory 130 may store various data, programs, or applications for operating and controlling the electronic device 100. A program stored in the memory 130 may include one or more instructions. A program (one or more instructions) or an application stored in the memory 130 may be executed by the processor 120.

When a power-off input is sensed, the processor 120 may perform a power-off operation. When the power-off operation is initiated, the processor 120 may monitor whether at least one process exhibits a suspicious activity. The processor 120 may monitor whether at least one process exhibits a suspicious activity between initiation of a power-off operation and closure of resources by legitimate processes, between closure of resources and power-off of the electronic device 100, or between power-off of the electronic device 100 and power-on of the electronic device 100. However, the present disclosure is not limited thereto.

When a suspicious activity is detected, the processor 120 may terminate the suspicious activity and delete a malicious process. Here, suspicious activities may include an activity for using an important resource included in the electronic device 100, an activity for accessing or modifying secure data, a secure process, privacy data, a privacy process, confidential data, or a confidential process, an activity for transmitting data to an external device, and an activity for downloading data (e.g., a malicious payload) from an external device. However, the present disclosure is not limited thereto.

For example, when a resource to be used by at least one process is an important resource, the processor 120 may prevent the process from accessing to the resource. When a power-off input is sensed, the processor 120 may invoke a power-off API. When at least one process requests an “open” system call for opening a resource after the power-off API is invoked, the processor 120 may determine whether the resource requested to be opened is an important resource. Here, if the resource requested to be opened is an important resource, the processor 120 may prevent the corresponding resource from being opened and terminate the process that requested to open the corresponding resource.

Furthermore, the processor 120 may generate a report regarding a suspicious activity or a suspicious process and control the electronic device 100 to be turned off. When the electronic device 100 is rebooted, the processor 120 may transmit the generated report to an external server (e.g., a security server).

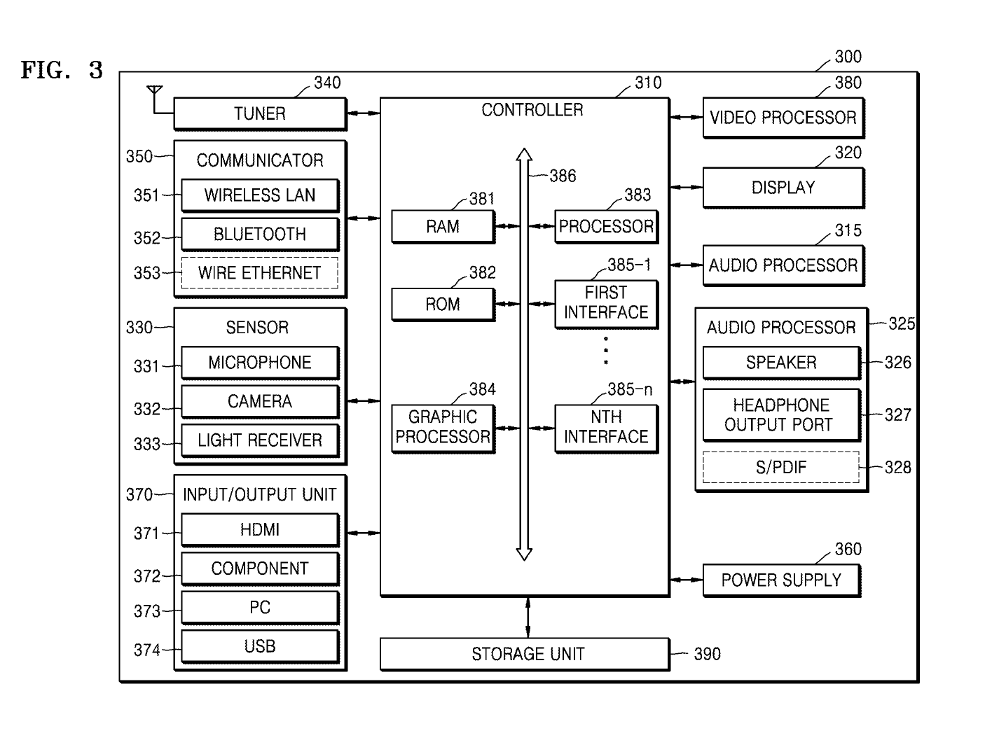

FIG. 3 is a block diagram illustrating an example configuration of an electronic device according to another example embodiment. An electronic device 300 of FIG. 3 may be another example embodiment of the electronic device 100 of FIG. 1.

Referring to FIG. 3, the electronic device 300 may include a controller 310, a display 320, a video processor 380, an audio processor 315, an audio output unit (e.g., including audio output circuitry) 325, a power supply 360, a tuner 340, a communicator (e.g., including communication circuitry) 350, a sensor (e.g., including sensing circuitry) 330, an input/output unit (e.g., including input/output circuitry) 370, and a storage unit 390.

The sensor 110 of FIG. 2 may correspond to the sensor 330 of FIG. 3, the processor 120 of FIG. 2 may correspond to the controller 310 of FIG. 3, and the memory 130 of FIG. 2 may correspond to the storage unit 390 of FIG. 3. Descriptions similar to those given above with reference to FIG. 2 will be omitted below.

The communicator 350 may include various communication circuitry configured to connect the electronic device 300 to an external device under the control of the controller 310. The controller 310 may transmit/receive content to/from an external device connected thereto, download an application from the external device, or browse web pages, via the communicator 350. Based on performance and structure of the electronic device 300, the communicator 350 may include various communication circuitry, such as, for example, and without limitation, at least one of a wireless LAN module 351, a Bluetooth module 352, and a wire Ethernet module 353. Furthermore, the communicator 350 may include a combination of communication circuitry including the wireless LAN module 351, the Bluetooth module 352, and the wire Ethernet module 353. The communication circuitry of the communicator 350 may receive a control signal of the control device 200 under the control of the controller 310. A control signal may be embodied as a Bluetooth signal, a RF signal, or a Wi-Fi signal.

The communicator 350 may include various other communication circuitry, including, but not limited to, short-range wireless communication modules other than the Bluetooth module, e.g., a near field communication (NFC) module (not shown), a Bluetooth low energy (BLE) module, etc.

The communication circuitry of the communicator 350 may transmit a report regarding a malware to a security server and receive a binary list corresponding to the malware.

The video processor 380 processes video data received by the electronic device 300. The video processor 380 may perform various image processing operations with regard to video data, such as decoding, scaling, noise filtering, frame rate conversion, and resolution conversion.

The display 320 transforms an image signal, a data signal, an OSD signal, and a control signal and generates a driving signal. The display 320 may be embodied as a plasma display panel (PDP), a liquid crystal display (LCD), an organic light-emitting display (OLED), a flexible display, or a 3-dimensional (3D) display. Furthermore, the display 320 may be configured as a touch screen and may be used not only as an output device, but also as an input device.

The display 320 displays a video included in a broadcasting signal received via the tuner 340 under the control of the controller 310. Furthermore, the display 320 may display content (e.g., moving pictures) input via the communicator 350 or the input/output unit 370. The display 320 may output an image stored in the storage unit 390 under the control of the display 320. Furthermore, the display 320 may display a voice user interface (UI) (e.g., a UI including a voice command guide) for performing a voice recognition task or a motion UI (e.g., a UI including a user motion guide for motion recognition) for performing a motion recognition task.

The audio processor 315 processes audio data. The audio processor 315 may perform various audio processing operations including decoding, amplification, and noise filtering with regard to audio data. Meanwhile, the audio processor 315 may include a plurality of audio processing modules for processing audio data corresponding to a plurality of contents.

The audio output unit 325 may include various audio output circuitry that outputs an audio included in a broadcasting signal received via the tuner 340 under the control of the controller 310. Furthermore, the audio output unit 325 may output an audio (e.g., a voice, a sound) input via the communicator 350 or the input/output unit 370. Furthermore, the audio output unit 325 may output an audio stored in the storage unit 390 under the control of the controller 310. The audio output unit 325 may include at least one of a speaker 326, a headphone output port 327, and a Sony/Philips digital interface (S/PDIF) output port 328. The audio output unit 325 may include a combination of the speaker 326, the headphone output port 327, and the S/PDIF output port 328.

The power supply 360 supplies power input from an external power source to internal components of the electronic device 300 under the control of the controller 310. Furthermore, the sensor 330 may supply power output by one, two, or more batteries (not shown) arranged in the electronic device 300 to the internal components of the electronic device 300 under the control of the controller 310

The tuner 340 may tune and select frequency corresponding to a channel to be received by the electronic device 300 from among a large number of frequency ingredients in a broadcasting signal that is received via a wire or wirelessly by amplifying, mixing, and resonating the broadcasting signal. Here, a broadcasting signal includes an audio data signal, a video signal, and additional information (e.g., electronic program guide (EPG)).

The tuner 340 may receive a broadcasting signal in a frequency band corresponding to a channel number (e.g., a cable broadcast No. 506) based on a user input (e.g., a control signal received from the control device 200, such as a channel number input, a channel up-down input, and a channel input on an EPG screen image).

The tuner 340 may receive a broadcasting signal from various sources, such as a ground wave broadcasting service, a cable broadcasting service, a satellite broadcasting service, and an internet broadcasting service. The tuner 340 may receive a broadcasting signal from sources like an analog broadcasting service or a digital broadcasting service. A broadcasting signal received by the tuner 340 is decoded (e.g., audio decoding, video decoding, or additional information decoding) and is split to an audio signal, a video signal, and/or additional information. The audio signal, the video signal, and/or the additional information obtained from the broadcasting signal may be stored in the storage unit 390 under the control of the controller 310.

The electronic device 300 may include one tuner 340 or a plurality of tuners 340. The tuner 340 may be integrated with the electronic device 300, may be embodied as an independent device (e.g., a set-top box (not shown)) having a tuner electrically connected to the electronic device 300, or may be embodied as a tuner connected to the input/output unit 370.

The sensor 330 includes various sensing circuitry that senses, for example, a voice of a user, an image of the user, or an interaction of the user. The sensor 330 may include various sensing circuitry, such as, for example, and without limitation, a microphone 331, a camera 332, and a light receiver 333. However, the present disclosure is not limited thereto.

The microphone 331 receives a voice uttered by a user. The microphone 331 may transform a received voice into an electric signal and output the electric signal to the controller 310. The microphone 331 may be integrated with the electronic device 300 or may be embodied as an independent device. The independent microphone 331 may be electrically connected to the electronic device 300 via the communicator 350 or the input/output unit 370. It would be apparent to one of ordinary skill in the art that the microphone 331 may be omitted according to performances and structures of the electronic device 300. The microphone 331 may transform a voice corresponding into a power-off input regarding the electronic device 300 to an electric signal and output the electric signal to the controller 310.

The camera 332 receives an image (e.g., successive frames) corresponding to a user's motion including a gesture within a recognition range of the camera 332. A user's motion may include a motion of a body part of the user, e.g., a face, a face expression, a hand, a fist, a finger, etc. The camera 332 may transform a received image into an electric signal and output the electric signal to the controller 310, under the control of the controller 310. The camera 332 may transform a motion (gesture) corresponding into a power-off input regarding the electronic device 300 to an electric signal and output the electric signal to the controller 310.

The controller 310 may select a menu displayed on the electronic device 300 by using a result of recognizing a received motion or perform a task corresponding to the result of the motion recognition, e.g., power on/off, changing channel, adjusting volume, moving a cursor, etc.

The camera 332 may include a lens (not shown) and an image sensor (not shown). The camera 332 may provide optical zoom or digital zoom by using a plurality of lenses and image processing techniques. The recognition range of the camera 332 may vary according to angles of the camera 332 and surrounding environmental conditions. If the camera 332 consists of a plurality of cameras, a 3-dimensional (3D) still image or a 3D motion may be received by using the plurality of cameras.

The camera 332 may be integrated with the electronic device 300 or may be embodied as an independent device. An independent device (not shown) including the camera 332 may be electrically connected to the electronic device 300 via the communicator 350 or the input/output unit 370.

It would be apparent to one of ordinary skill in the art that the camera 332 may be omitted according to performances and structures of the electronic device 300.

The light receiver 333 receives an optical signal (including a control signal) from the external control device 200 via an optical window (not shown) of the bezel of the display 320. The light receiver 333 may receive an optical signal corresponding to a user input (e.g., a touch, a press, a touch gesture, a voice, or a motion) from the control device 200. A control signal may be extracted from the received optical signal under the control of the controller 310.

The light receiver 333 may receive an optical signal corresponding into a power-off input regarding the electronic device 300 from the control device 200.

The input/output unit 370 may include various input/output circuitry that receives a video (e.g., moving pictures, etc.), an audio (e.g., voice, music, etc.), and additional information (e.g., an EPG, etc.) from outside of the electronic device 300 under the control of the controller 310. The input/output unit 370 may include various input/output circuitry, including, for example, and without limitation, at least one of a high-definition multimedia interface port 371, a component jack 372, a PC port 373, and a USB port 374. The input/output unit 370 may include a combination of input/output circuitry, including, for example, the HDMI port 371, the component jack 372, the PC port 373, and the USB port 374.

It would be apparent to one of ordinary skill in the art that configurations and operations of the input/output unit 370 may vary according to embodiments of the present disclosure.

The controller 310 controls the overall operations of the electronic device 300, controls signal flows between internal components of the electronic device 300, and processes data. When a user input is applied or a certain condition is satisfied, the controller 310 may execute an operating system (OS) and various applications stored in the storage unit 390.

The controller 310 may process an image signal and input the processed image signal to the display 320. Therefore, an image corresponding to the corresponding image signal may be displayed at the display 320. Furthermore, the controller 310 may control the electronic device 300 based on a user command sensed by the sensor 330 or an internal program.

The controller 310 may include a RAM 381 that stores a signal or data received from outside of the electronic device 300 or is used as a storage area corresponding to various tasks performed by the electronic device 300, a ROM 382 having stored therein control programs for controlling the electronic device 300, and a processor 383.

The processor 383 may include a graphics processing unit (GPU) (not shown) for processing graphics data corresponding to a video. The processor 383 may be embodied as a system-on-chip (SoC) having integrated thereon a core (not shown) and a GPU (not shown).

A graphics processor 384 generates a screen image including various objects, such as icons, images, and texts, by using a processor (not shown) and a renderer (not shown). The processor calculates property values, such as coordinate values, shapes, sizes, and colors, for displaying respective objects according to a layout of a screen image by using a user input sensed by the sensor 330. The renderer generates screen images having various layouts including objects based on property values calculated by the processor. A screen image generated by the renderer is displayed within a display area of the display 320.

First through nth interfaces 385-1 through 385-n are connected to the above-stated components. One of the first through nth interfaces 385-1 through 385-n may be a network interface that is connected to an external device via a network.

The RAM 381, the ROM 382, the processor 383, the graphics processor 384, and the first through nth interfaces 385-1 through 385-n may be connected to one another via an internal bus 386.

In the present embodiment, the term ‘control unit’ may, for example, include the processor 383, the ROM 382, and the RAM 381.

The storage unit 390 may include a memory or storage that stores various data, programs, or applications for operating and controlling the electronic device 300 under the control of the controller 310. The storage unit 390 may store signals or data input/output in correspondence to operations of the video processor 380, the display 320, the audio processor 315, the audio output unit 325, the sensor 330, the tuner 340, the communicator 350, the sensor 330, and the input/output unit 370. The storage unit 390 may store control programs for controlling the electronic device 300 and the controller 310, applications initially provided by a manufacturer of the electronic device 300 or downloaded from outside, graphical user interfaces (GUI) related to the applications, objects (e.g., images, texts, icons, buttons, etc.) for providing the GUIs, user information, documents, databases, or data related thereto.

Furthermore, the storage unit 390 may store a list of important resources and a binary list regarding malwares.

According to an embodiment, the term “storage unit” may, for example, include the storage unit 390, the ROM 382 and the RAM 381 of the controller 310, and/or a memory card (not shown) attached to the electronic device 300 (e.g., a micro SD card, a USB memory, etc.). Furthermore, the storage unit 390 may include a non-volatile memory, a volatile memory, a hard disk drive (HDD), or a solid state disk (SSD).

Although not shown, the storage unit 390 may include a broadcast receiving module, a channel control module, a volume control module, a communication control module, a voice recognition module, a motion recognition module, an optical receiving module, a display control module, an audio control module, an external input control module, a power control module, a module for controlling a wirelessly connected external device (e.g., connected via a Bluetooth communication), a voice database (DB), or a motion DB. The modules (not shown) and the DB (not shown) of the storage unit 390 may be embodied in the form of software for controlling the electronic device 300 to perform a broadcast reception control function, a channel control function, a volume control function, a communication control function, a voice recognition function, a motion recognition function, an optical reception control function, a display control function, an audio control function, an external input control function, a power control function, or a function for controlling a wirelessly connected external device (e.g., connected via a Bluetooth communication). The controller 310 may perform the above-stated functions by using the software modules stored in the storage unit 390.

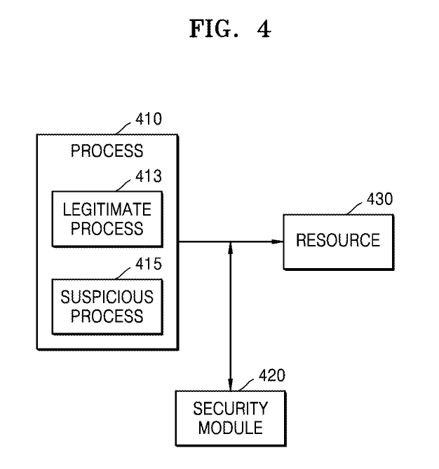

Meanwhile, software including a security module may be stored in the storage unit 390. A security module is a program module that supports hardware certification, permission, secure storage, and malware detection. Operations of a security module according to an embodiment will be described below in detail with reference to FIG. 4.

Meanwhile, the block diagrams of the electronic devices 100 and 300 illustrated in FIGS. 2 and 3 are block diagrams illustrating mere example embodiments. Components illustrated in FIGS. 2 and 3 may be integrated with one another, may include additional components, or may be omitted according to the specifications of the actual electronic devices 100 and 300. In other words, if necessary, two or more components may be combined into a single component or a single component may be split into two or more components. Furthermore, functions performed by respective components are merely for describing embodiments and do not construe the present disclosure.

FIG. 4 is a diagram illustrating an example method of operating a security module according to an example embodiment.

As illustrated in FIG. 4, processes 410 executed on an electronic device according to an example embodiment may include a legitimate process 413 and a suspicious process 415. For example, the legitimate process 413 may refer to a legitimate process that is performed to turn off the electronic device 100 after a power-off input is sensed. When a power-off input is sensed, the legitimate process 413 closes resources included in the electronic device 100.

On the other hand, the suspicious process 415 may refer to a process that accesses or attempts to use an important resource of the electronic device 100 after a power-off input is sensed.

A resource 430 may include a device resource. Device resource refers to a component of hardware, software, or data included in the electronic device 100 and may include data or routines that may be utilized by programs. For example, software resource may include programs, utilities, and small components in programs, whereas data resources may include accessible files or accessible databases.

Important resources included in the electronic device 100 according to an embodiment may include, for example, a camera, a microphone, a network, and a file system, but are not limited thereto.

The security module 420 may refer, for example, to a module for monitoring whether at least one process exhibits a suspicious activity between initiation of a power-off operation and closure of resources by legitimate processes, between closure of resources and power-off of the electronic device 100, or between power-off of the electronic device 100 and power-on of the electronic device 100.

For example, the security module 420 may be configured to hook a power-off APU and an “open” system call. After a power-off input is sensed and a power-off API is invoked, if an “open” system call for opening a resource is requested by at least one process, the security module 420 may detect the corresponding resource requested to be opened.

The security module 420 may determine whether the detected resource is an important resource. For example, the security module 420 may determine whether the detected resource is an important resource by determining whether the detected resource is included in an important resource list. However, the present disclosure is not limited thereto.

If the detected resource is not an important resource, the process requested to open the detected resource may be a legitimate process, and the corresponding resource may be permitted to be opened.

On the other hand, if the detected resource is an important resource, the security module 420 may prevent the detected resource from being opened by the process and terminate the process.

A binary regarding each process according to an example embodiment may be included in one of a blacklist, a white list, and an unknown list.

For example, a binary that does not include a valid digital signature of a manufacturer and has been previously confirmed as a malware may be included in a blacklist, a binary with a valid digital signature of a manufacturer may be included in a white list, and a binary that does not include a valid digital signature of a manufacturer and has not been previously confirmed as a malware may be included in an unknown list.

The electronic device 100 may include at least one of a black list, a white list, and an unknown list or receive the same from an external server.

The security module 420 may determine which of the lists includes a binary regarding a process that attempted to open a resource. If the binary regarding the process that attempted to open the resource is included in the black list or the unknown list, the security module 420 may delete the binary.

Furthermore, the security module 420 may generate a report regarding the detected resource and the process that attempted to open the resource. Here, the report may include name of the process, name of the binary, a binary hash (MD5 or SAH-256), name of the resource that the process attempted to open, and a binary file. However, the present disclosure is not limited thereto. The security module 420 may transmit the generated report to an external server when the electronic device 100 is rebooted.

The security module 420 may be software executed in a secure world of a processor to be protected from malwares. A processor according to an embodiment may include a secure world and a normal world for executing normal software. The secure world is a world separated from the normal world for higher security level than the normal world, where a separate secure OS is installed and executed in the secure world. Furthermore, the secure world may communicate with the normal world via a limited interface.

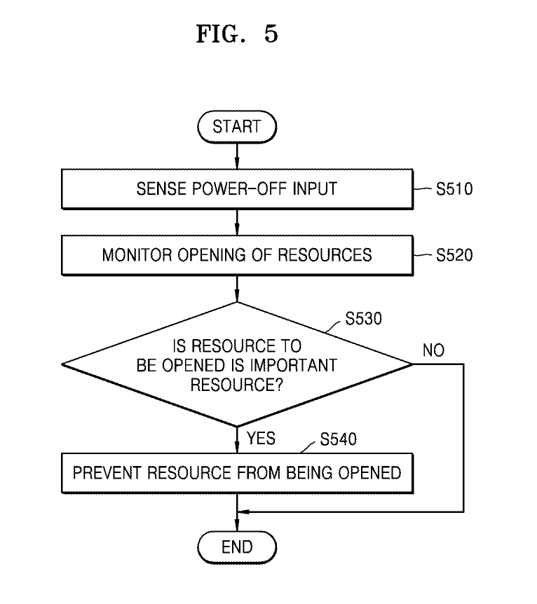

FIG. 5 is a flowchart illustrating an example method of operating an electronic device according to an example embodiment.

Referring to FIG. 5, an electronic device 100 may sense a power-off input (operation S510).

For example, the electronic device 100 may sense input of a power-off button included in the electronic device 100, sense input of a power-off button included in a control device 200, or sense a voice or a gesture of a user corresponding to a power-off command. Alternatively, if a time to turn off the electronic device 100 is set in advance, the electronic device 100 may sense whether the set time arrived. However, the present disclosure is not limited thereto.

When a power-off input is sensed, the electronic device 100 may monitor opening of resources by at least one process (operation S520).

When a power-off input is sensed, the electronic device 100 may monitor opening of resources by at least one process between initiation of a power-off operation and power-off of the electronic device 100. Alternatively, the electronic device 100 may monitor opening of resources by at least one process between power-off of the electronic device 100 and power-on of the electronic device 100.

When an “open” system call regarding a resource is requested by at least one process, the electronic device 100 may determine whether the resource requested to be opened is an important resource (operation S530).

If the resource requested to be used is an important resource, the electronic device 100 may prevent the corresponding resource from being opened by the process (operation S540).

Meanwhile, the electronic device 100 according to an embodiment may monitor not only whether a resource is opened by at least one process, but also whether at least one process exhibits a suspicious activity. For example, the electronic device 100 may detect an activity for using an important resource included in the electronic device 100, an activity for accessing or modifying secure data, a secure process, privacy data, a privacy process, confidential data, or a confidential process, and an activity for downloading data (e.g., a malicious payload) from an external device. However, the present disclosure is not limited thereto. When a suspicious activity is detected, the electronic device 100 may terminate the suspicious activity.

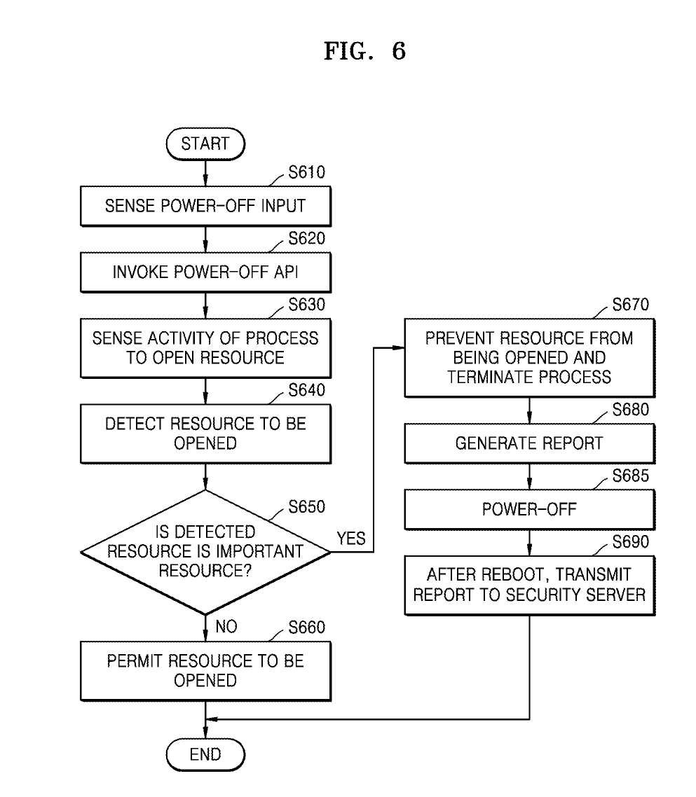

FIG. 6 is a flowchart illustrating an example method of operating an electronic device according to an example embodiment.

Referring to FIG. 6, an electronic device 100 may sense a power-off input (operation S610).

When a power-off input is sensed, the electronic device 100 may invoke a power-off API (operation S620).

The electronic device 100 may sense an activity of at least one process for opening a resource (operation S630). For example, in case of opening a resource included in the electronic device 100, at least one process may request an “open” system call regarding the resource.

When an “open” system call is requested, the electronic device 100 may detect a resource to be opened (operation S640). For example, the electronic device 100 may fetch information regarding a resource to be opened and a process attempting to open the resource by using parameters included in an “open” system call.

The electronic device 100 may determine whether a detected resource is an important resource (operation S650). For example, the electronic device 100 may determine the detected resource is an important resource by determining whether the detected resource is included in an important resource list. However, the present disclosure is not limited thereto.

If the detected resource is not an important resource, the detected resource may be permitted to be opened (operation S660).

On the other hand, if the detected resource is an important resource, the electronic device 100 may prevent the detected resource from being opened by the process and terminate the process (operation S670).

Furthermore, if a binary regarding the process that attempted to open the detected resource does not include a valid digital signature of a manufacturer, the electronic device 100 may delete the corresponding binary.

Furthermore, the electronic device 100 may generate a report regarding the detected resource and the process that attempted to open the detected resource (operation S680). Here, the report may include name of the process, name of the binary, a binary hash (MD5 or SAH-256), name of the resource that the process attempted to open, and a binary file. However, the present disclosure is not limited thereto.

The electronic device 100 may be turned off (operation S685).

When the electronic device 100 is rebooted, the electronic device 100 may transmit the generated report to an external server (operation S690).

Meanwhile, although the operation S610 and the operation S620 show a case where the power-off input is sensed and the power-off API is invoked, the present disclosure is not limited thereto.

For example, in the electronic device 100, the operations S630 through S690 may be performed even when an IoT API is invoked in order to perform operations related to the Internet of Things (IoT) or a business-to-business (B2B) API is invoked in order to perform B2B-related operations.

According to an embodiment, an electronic device may monitor and block a suspicious activity, such as opening of an important resource by malicious software, even while the electronic device is being turned off.

According to another embodiment, an electronic device may detect malicious software and delete a binary corresponding to the malicious software even while the electronic device is being turned off, thereby protecting the electronic device.

The above-described example embodiments of the present disclosure may be implemented as programmable instructions executable by a variety of computer components and stored in a non-transitory computer readable recording medium. The non-transitory computer readable recording medium may include program instructions, a data file, a data structure, or any combination thereof. The program instructions stored in the non-transitory computer readable recording medium may be designed and configured specifically for the present disclosure or can be publicly known and available to those of ordinary skill in the field of software. Examples of the non-transitory computer readable recording medium include a hardware device configured to store and perform program instructions, for example, a magnetic medium, such as a hard disk, a floppy disk, and a magnetic tape, an optical recording medium, such as a CD-ROM, a DVD, and the like, a magneto-optical medium, such as a floptical disc, a ROM, a RAM, a flash memory, and the like. Examples of the program instructions include machine codes made by, for example, a compiler, as well as high-level language codes executable by a computer using an interpreter.

While one or more example embodiments have been described with reference to the figures, it will be understood by those of ordinary skill in the art that various changes in form and details may be made therein without departing from the spirit and scope as defined by the following claims.

What is claimed is:

1. An electronic device comprising:
a sensor including sensing circuitry configured to detect a power-off input regarding the electronic device;
a processor;
a memory storing one or more programs including instructions to be executed by the processor; and
the processor being configured to execute instructions of the one or more programs to perform operations comprising, monitoring use of resources included in the electronic device by at least one process when the power off input is detected, and preventing a resource from being opened if the resource to be opened by the at least one process is a predetermined resource.

2. The electronic device of claim 1, wherein the one or more programs further comprise instructions for terminating the at least one process if the resource to be opened by the at least one process is the predetermined resource.

3. The electronic device of claim 1, wherein the one or more programs further comprise instructions for invoking a power-off API when the power-off input is detected, monitoring an activity of the at least one process to open the resource after the power-off API is invoked, and determining whether the resource to be opened is the predetermined resource.

4. The electronic device of claim 3, wherein the memory comprises a security module configured to hook the power-off API and an open system call regarding the resource, to monitor opening of the resource by the at least one process.

5. The electronic device of claim 4, wherein the processor comprises a secure environment, and
the one or more programs further comprise instructions for executing the security module in the secure environment.

6. The electronic device of claim 1, wherein the memory stores a first list comprising at least one binary that does not include a valid digital signature and corresponds to a malicious software, and
the one or more programs further comprise instructions for detecting a binary corresponding to the at least one process and deleting the binary corresponding to the at least one process if the detected binary is included in the first list.

7. The electronic device of claim 6, further comprising communication circuitry configured to receive the first list from an external server.

8. The electronic device of claim 1, further comprising communication circuitry,
wherein the one or more programs further comprise instructions for generating a report regarding the activity of the at least one process attempting to open the resource if the resource is the predetermined resource, and transmitting the report to an external server when the electronic device is rebooted.

9. A method of operating an electronic device, the method comprising:
sensing a power-off input received by the electronic device;
monitoring use of resources included in the electronic device by at least one process; and
preventing the resource from being opened if the resource to be used by the at least one process is a predetermined resource.

10. The method of claim 9, further comprising terminating the at least one process if the resource to be used by the at least one process is the predetermined resource.

11. The method of claim 9, further comprising, invoking a power-off API when receiving a power-off input is sensed,
wherein the monitoring of the use of the resources comprises:
monitoring an activity of the at least one process to open the resource after the power-off API is invoked; and
determining whether the resource to be opened is the predetermined resource.

12. The method of claim 11, further comprising hooking the power-off API and an open system call of the resource.

13. The method of claim 9, further comprising:
storing a first list comprising at least one binary that does not include a valid digital signature and that corresponds to malicious software;
detecting a binary corresponding to the at least one process; and,
deleting the binary corresponding to the at least one process if the detected binary is included in the first list.

14. The method of claim 13, further comprising receiving the first list from an external server.

15. The method of claim 9, further comprising:
generating a report regarding the activity of the at least one process attempted to open the resource if the resource is the predetermined resource; and,
transmitting the report to an external server when the electronic device is rebooted.

16. A non-transitory computer readable recording medium having recorded thereon a computer program which, when executed by a processor causes the processor to perform the method of claim 9.
